(19) United States
(12) Patent Application Publication
(10) Pub. No.: US 2016/0214713 A1
(43) Pub. Date: Jul. 28, 2016

(54) UNMANNED AERIAL VEHICLE WITH LIGHTS, AUDIO AND VIDEO

(71) Applicant: Brandon Cragg, Lauderdale by the Sea, FL (US)

(72) Inventor: Brandon Cragg, Lauderdale by the Sea, FL (US)

(21) Appl. No.: 14/974,877

(22) Filed: Dec. 18, 2015

Related U.S. Application Data
(60) Provisional application No. 62/094,554, filed on Dec. 19, 2014.

(51) Int. Cl. B64C 39/02; B64D 47/00; B64C 27/32; B64D 47/02; B64C 27/08; B64D 47/08

(52) U.S. Cl. CPC B64C 39/024; B64C 27/08; B64D 47/08; B64C 27/32; B64D 47/02; B64D 47/00; B64C 2201/146; B64C 2201/108; B64C 2201/12

(57) ABSTRACT

An unmanned aerial vehicle (i.e., drone) has a main body having top and bottom halves shaped to resemble beverage bottle caps, and hinged to one another in a clamshell arrangement to surround an interior compartment. The main body is mounted on a landing gear structure having at least two support legs. For propulsion, multiple rotors (e.g., 4 to 6) are each mounted on collapsible booms that are hingedly mounted to the frame structure of the landing gear assembly. The unmanned aerial vehicle is equipped with spotlights, LEDs that change color, laser lights, strobe lights, multiple speakers, a video display screen, a video camera, a video projector, a satellite/GPS antennae, a digital music storage and playing device, a voice recording and playback device connected to the multiple speakers, at least one battery power source and a computer control module (CPU) for wireless communication with a remote control device.

### BACKGROUND OF THE INVENTION

1. Field of the Invention

The present invention relates to an unmanned aerial vehicle (i.e., drone) that is equipped with various types of lights including LEDs, spotlights, strobe lights and laser lights, an audio storage and playback device connected to multiple speakers, a video display, along with a video camera, video projector, and a computer control module (CPU).

2. Discussion of the Related Art

An unmanned aerial vehicle (UAV), commonly known as a drone, is an aircraft without a human pilot aboard. The flight of drones is typically controlled either autonomously by onboard computers or by the remote control of a pilot on the ground or in another vehicle. Unmanned aerial vehicles, or drones, were initially developed for military purposes to carry weapons or to conduct surveillance. In recent years, however, use of drones has become increasingly popular for various civilian applications, such as for law enforcement, firefighting, non-military security work, and aerial photography. In the real-estate sales industry, use of drones has become quite popular to replace piloted aircrafts such as helicopters, in order to take still photo aerial images and aerial motion video recordings in order to promote a property for sale. The use of drones is now being considered for purposes of delivering packages from a shipping center to recipients within a predefined range from the shipping center.

### SUMMARY OF THE INVENTION

An unmanned aerial vehicle (i.e., drone) has a main body having a top half and a bottom half preferably shaped to resemble beverage bottle caps, and hinged to one another in a clamshell arrangement to surround an interior compartment. The main body is mounted on a landing gear structure having at least two support legs. For propulsion, multiple rotors (e.g., 4 to 6) are each mounted on collapsible booms that are hingedly mounted to the frame structure of the landing gear assembly. The unmanned aerial vehicle is equipped with spotlights, LEDs that change color, laser lights, strobe lights, multiple speakers, a video display screen, a video camera, a video projector, a satellite/GPS antennae, a digital music storage device for playing music from the multiple speakers, a voice recording and playback device connected to the multiple speakers, at least one battery power source and a computer control module (CPU) for wireless communication with a remote control device.

### OBJECTS AND ADVANTAGES OF THE INVENTION

The present invention proposes the use of unmanned aerial vehicles (i.e., drones) for entertainment and promotional purposes. Accordingly, it is the object of the present invention to provide an unmanned aerial vehicle that is equipped with various types of lights, audio speakers, at least one video display screen, a still photo camera, a video camera, a video projector for projecting still or motion pictures onto a ground or wall surface or other object.

It is a further object of the present invention to provide a drone that can play recorded or live feed audio, such as music or voice, from a plurality of speakers supported on the drone.

It is still a further object of the present invention to provide a drone having a plurality of lights including LEDs that change color, spotlights, strobe lights, landing lights and laser lights.

It is still a further object of the present invention to provide a drone that is responsive to voice commands.

It is still a further object of the present invention to provide a drone that talks via a prerecorded voice storage device connected to the plurality of audio speakers or via a live voice feed such as a wireless voice communication device (i.e., cell phone, smart phone, radio communication device).

It is yet a further object of the present invention to provide a drone that has a main drone body formed in the shape of two bottle caps arranged in a clamshell design.

It is yet a further object of the present invention to provide a drone that includes a main drone body formed and configured as a barbecue grill.

These and other objects and advantages of the invention are readily apparent with reference to the accompanying drawing images.

### BRIEF DESCRIPTION OF THE DRAWINGS

For a fuller understanding of the nature of the present invention, reference should be made to the accompanying drawings wherein:

FIG. 1 is a front, top perspective view of the unmanned aerial vehicle in accordance with a preferred embodiment of the present invention;

FIG. 2 is a perspective view showing the inside of the main drone body, with the top portion of the drone body hinged open to reveal the numerous components carried within the main drone body including, but not limited to, a remote control for LED lights, strobe lights, laser lights, spotlights, and/or landing lights, a satellite/GPS antennae, a voice recording and storage device, a plurality of audio speakers, and one or more battery power storage packs;

FIG. 3 is an isolated perspective view showing the upper portion or lid of the main drone body having a bottle cap shape, along with an arrangement of LED lights mounted there to adapted to change color and are operated by a remote control, FIG. 3 further showing the wiring harness from the proportion to the main components stored in the interior of the lower portion of the main body;

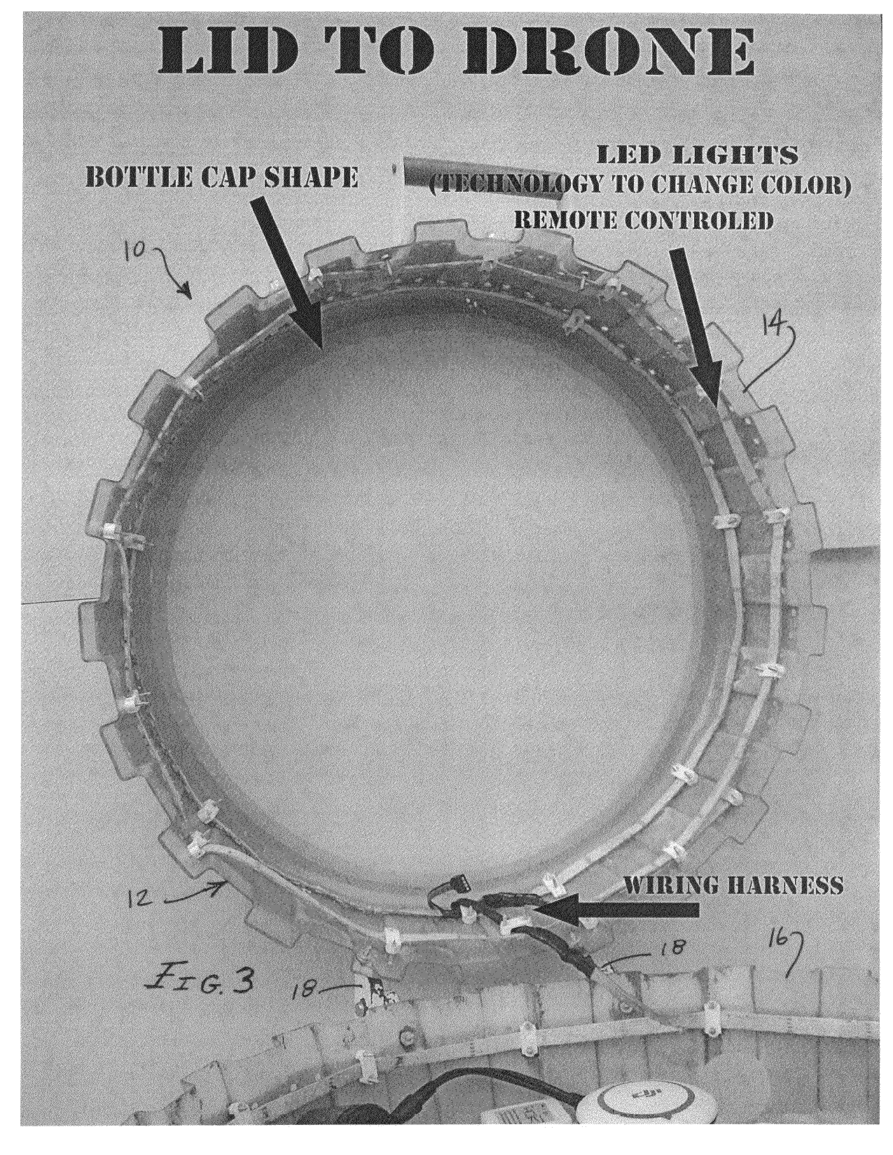

FIG. 4 is a front perspective view of the unmanned aerial vehicle with the lid of the main body raised and rotors and booms collapsed below the main body;

FIG. 5 is a top perspective view showing the interior of the lower portion of the main body housing the numerous components therein including a wiring arrangement of the components; and

FIG. 6 is a bottom perspective view of an unmanned aerial vehicle illustrating an arrangement of landing lights and/or strobe lights on the bottom of the main body.

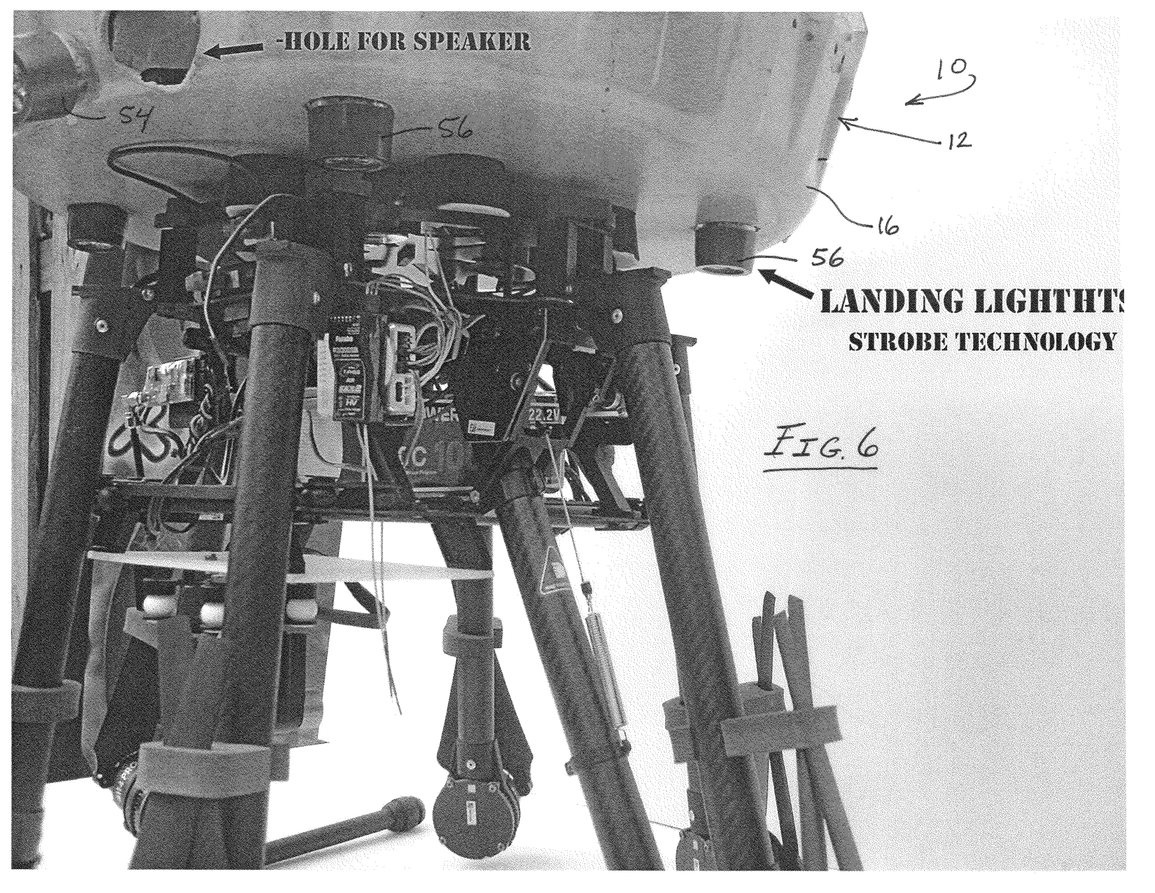

### DETAILED DESCRIPTION OF THE PREFERRED EMBODIMENT

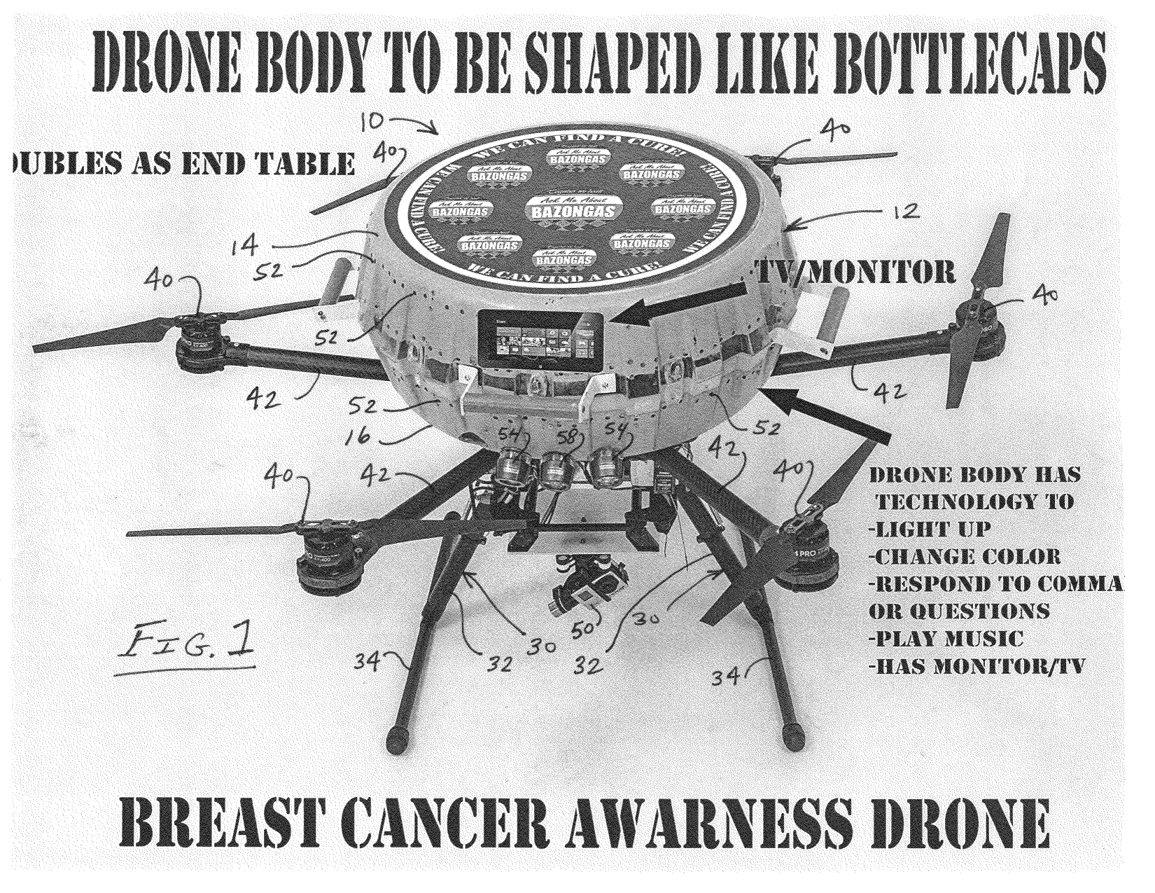

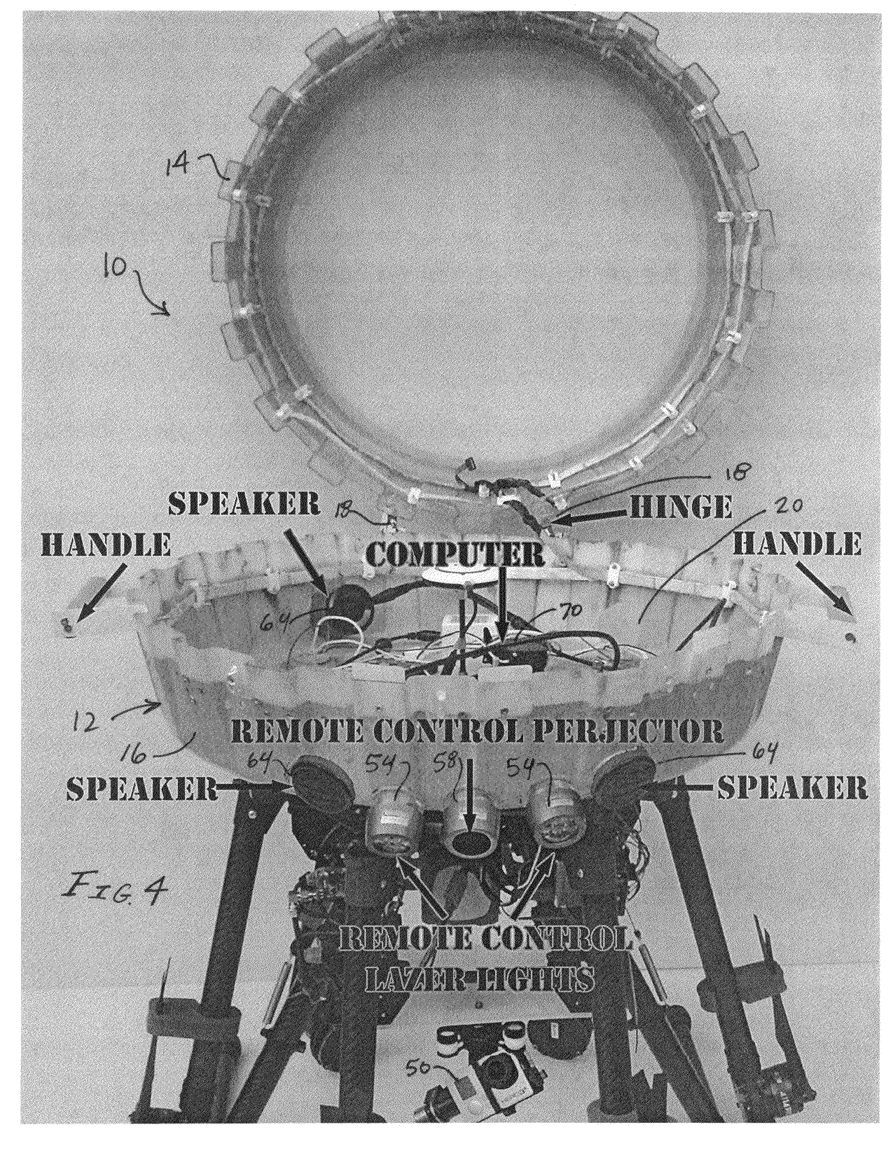

Referring to the several views of the drawings, and initially FIGS. 1 and 4, the unmanned aerial vehicle of the present invention is shown and is generally indicated as 10. The unmanned aerial vehicle 10 has a main body 12 that includes a top half 14 and a bottom half 16. The top and bottom halves are hinged to one another by one or more hinges 18 to allow the top half 14 to lift and hinge open (see FIG. 4) in order to allow access to an interior compartment 20 that houses a number of components. In a preferred embodiment, the top half 14 and the bottom half 16 are each shaped to resemble a beverage bottle cap. The top half 14 and bottom half 16 are arranged so that the bottom half bottle cap shape is inverted. The top half 14 and the bottom half 16 are hinged in a clamshell arrangement so that when the top half is closed onto the bottom half the top half 14 and bottom half 16 surround the interior compartment 20.

The main body 12 is mounted on a landing gear structure 30 having at least two support legs 32. A horizontal landing gear foot 34 may be fitted to the end of each of the support legs 32 for stability and balance when the unmanned aerial vehicle 10 lands and rests on a ground surface.

The unmanned aerial vehicle 10 is propelled by multiple rotors 40, each mounted on the end of a collapsible boom 42. The booms 42 are hingedly mounted to the frame structure of the landing gear assembly 30 allowing the booms 42, with the rotors 40 on the ends to be collapsed down, as seen in FIG. 4, for purposes of storage and transport. In operation, the booms 42 are extended and locked in the extending position, as seen in FIG. 1. In a preferred embodiment, there are six rotors 40, each supported on the end of their own respective boom 42. The rotors 40 rotate at variable speeds, by control, to allow the unmanned aerial vehicle to ascend, descend and fly through the air, above a ground surface.

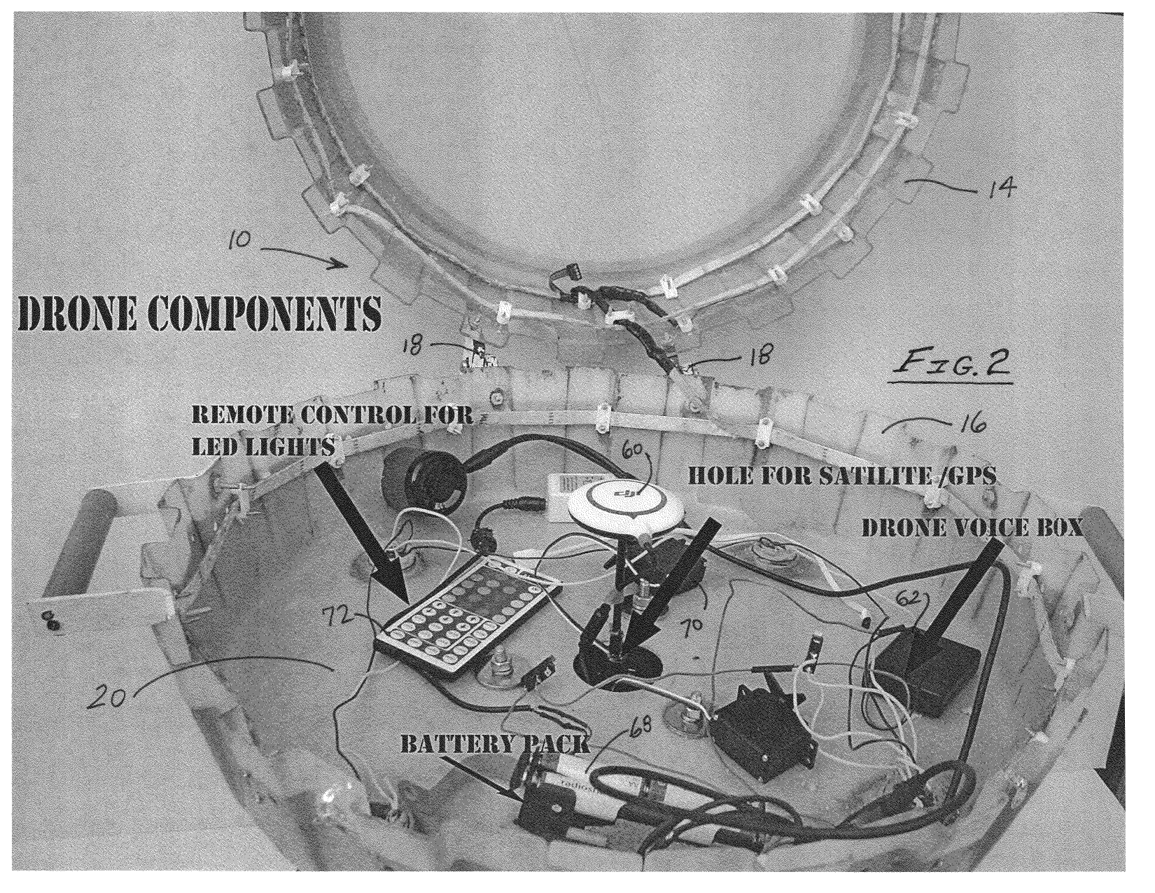

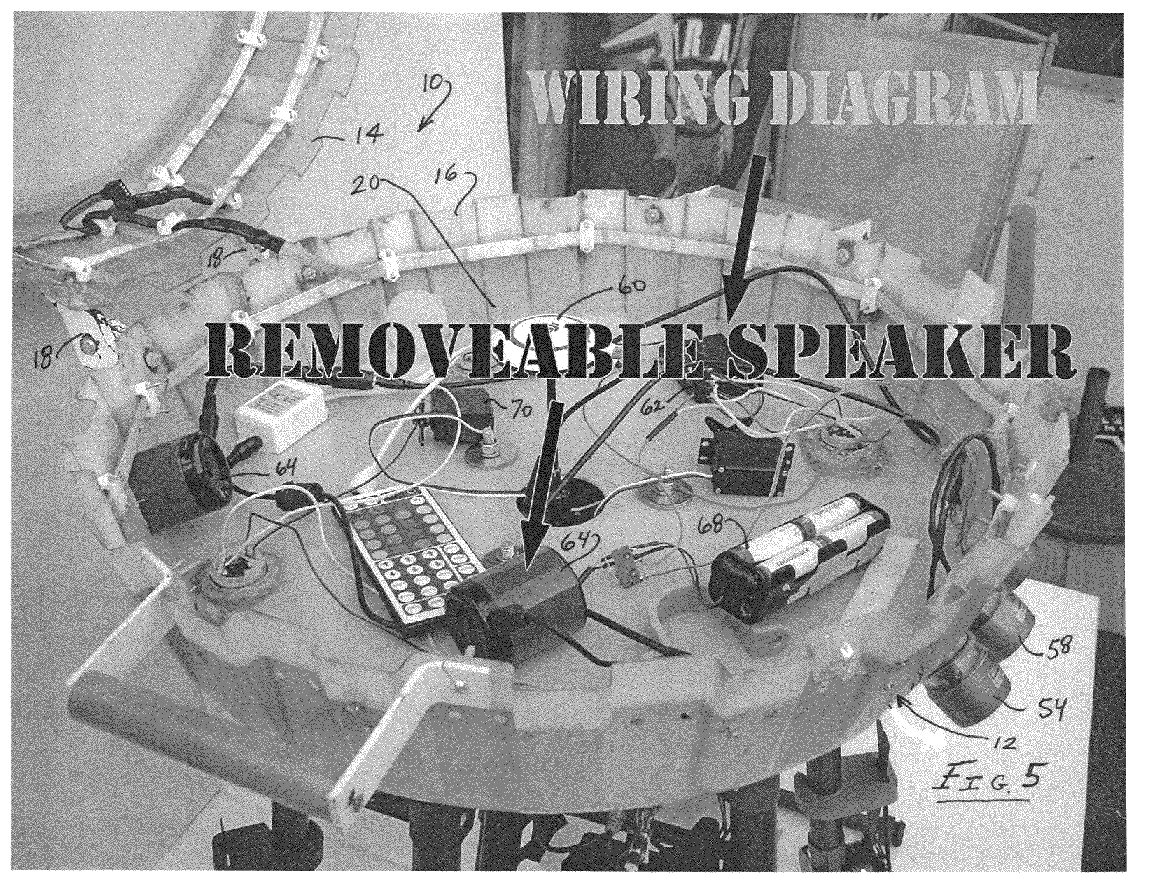

The unmanned aerial vehicle 10 is equipped with a video camera 50, spotlights, LEDs 52 that change color, laser lights 54 and strobe lights and/or landing lights 56. On a forward portion of the bottom half of the housing, the unmanned aerial vehicle is fitted with remote controlled laser lights 54 and a remote control projector 58 that projects video or still images onto a surface that is separated from the drone, such as the ground surface below the flying unmanned aerial vehicle. As seen in FIGS. 2, 4 and 5, the interior components supported within the interior compartment 20 include a satellite/GPS antenna 60, a voice box 62, removable speakers 64 and a battery power source 68. The computer control module 70 controls operation of the various components and communicates with a remote control 72 which can be used to operate the various lights, as well as the speakers and a digital music storage and playing device.

The computer control 70 module may further include wireless communication technology in order to allow it to communicate with both the remote control 72 as well as a cell phone, smartphone or other portable electronic device. The computer control module 70 and unmanned aerial vehicle 10 may further be adapted to respond to voice commands received from a wireless electronic device, such as a cell phone. These voice commands can be used to control the various components of the unmanned aerial vehicle 10, including the propulsion system. The speakers may further be used to emit audio from a remote wireless electronic device, such as a cell phone, including digital music stored on the cell phone or other electronic device, as well as a person's voice in a wireless speaker mode, wherein a person speaking through the wireless device (e.g., cell phone) can have their voice emitted out from the speakers 64 from the flying unmanned aerial vehicle 10.

What is claimed is:

1. An unmanned aerial vehicle comprising:
a main body including a top half and a bottom half, said top half being hinged to said bottom half to allow movement of said top half between a closed position in surrounding, enclosing relation to an interior compartment and a raised, open position to allow access to the interior compartment;
a landing gear structure mounted to said main body;
a propulsion system for allowing ascent, descent and air travel of the unmanned aerial vehicle above a ground surface, and said propulsion system including a plurality of rotors each mounted to the end of a boom attached to and extending from the landing gear structure;
at least one LED on said main body;
a satetlite/GPS antenna on said main body;
at least one audio speaker on said main body;
a video camera supported on said main body;
a video projector mounted to said main body; and
a computer control module supported within the interior compartment for controlling operation of at least the propulsion system.
